(19) United States
(12) Patent Application Publication
(10) Pub. No.: US 2017/0208733 A1
(43) Pub. Date: Jul. 27, 2017

(54) Lift Attachment System

(71) Applicant: David Nelson Sterchi, South Pittsburg, TN (US)

(72) Inventor: David Nelson Sterchi, South Pittsburg, TN (US)

(21) Appl. No.: 15/004,386

(22) Filed: Jan. 22, 2016

(51) Int. Cl. A01B 63/02; A01G 1/12; A01B 63/00; A01B 45/00

(52) U.S. Cl. CPC A01B 63/02; A01B 45/00; A01G 1/12; A01B 63/008

(57) ABSTRACT

A lift attachment system for providing adjustment such as lifting and lower to various attachments being towed by a vehicle. The system generally includes a base frame which is removably connected to a vehicle, such as at its rear frame. A support frame is pivotally connected to the base frame. An actuator is connected between the support frame and the base frame such that the support frame may pivotally adjust with respect to the base frame. The support frame includes a width-adjustable attachment mount which is adapted to removably receive one of a plurality of different attachments. By removably connecting the attachment to the support frame, the attachment may be pivotally adjusted (such as lifted or lowered) via activation of the actuator. By connecting the base frame to a vehicle, one may adjust an attachment while in use on a vehicle to improve efficiency and prevent constant manual adjustments.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

Field

Example embodiments in general relate to a lift attachment system for providing adjustment such as lifting and lower to various attachments being towed by a vehicle.

Related Art

Any discussion of the related art throughout the specification should in no way be considered as an admission that such related art is widely known or forms part of common general knowledge in the field.

Various attachments are available for a wide range of vehicles across a number of industries. For example, yard tractors are commonly used both in industrial and residential areas. Various attachments are towed behind the yard tractors. When pulling such attachments behind yard tractors, they tend to tear up the ground surface when turning or backing up.

Further, these attachments are highly susceptible to jackknifing when backing up, which can cause damage to the ground, tires, or the attachment itself. Without efficient adjustment of the attachment, an operator is forced to continuously manually disconnected or adjust the attachment to prevent damage when turning or backing up.

### SUMMARY

An example embodiment of the present invention is directed to a lift attachment system. The lift attachment system includes a base frame which is removably connected to a vehicle, such as at its rear frame. A support frame is pivotally connected to the base frame. An actuator is connected between the support frame and the base frame such that the support frame may pivotally adjust with respect to the base frame. The support frame includes a width-adjustable attachment mount which is adapted to removably receive one of a plurality of different attachments. By removably connecting the attachment to the support frame, the attachment may be pivotally adjusted (such as lifted or lowered) via activation of the actuator. By connecting the base frame to a vehicle, one may adjust an attachment while in use on a vehicle to improve efficiency and prevent constant manual adjustments.

There has thus been outlined, rather broadly, some of the features of the lift attachment system in order that the detailed description thereof may be better understood, and in order that the present contribution to the art may be better appreciated. There are additional features of the lift attachment system that will be described hereinafter and that will form the subject matter of the claims appended hereto. In this respect, before explaining at least one embodiment of the lift attachment system in detail, it is to be understood that the lift attachment system is not limited in its application to the details of construction or to the arrangements of the components set forth in the following description or illustrated in the drawings. The lift attachment system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a lift attachment system in accordance with an example embodiment.

FIG. 2 is a bottom view of a lift attachment system in accordance with an example embodiment.

FIG. 3 is a side view of the attachment in a levelled position.

FIG. 4 is a side view of the attachment in a raised position.

FIG. 5 is a side view of the attachment in a lowered position.

FIG. 6 is a frontal perspective view of a lift attachment system with an attachment in accordance with an example embodiment.

FIG. 7 is a frontal perspective view of a lift attachment system without an attachment in accordance with an example embodiment.

FIG. 8 is a rear perspective view of a lift attachment system with an attachment in accordance with an example embodiment.

FIG. 9 is a rear perspective view of a lift attachment system without an attachment in accordance with an example embodiment.

FIG. 10 is a first side view of a lift attachment system in accordance with an example embodiment.

FIG. 11 is a second side view of a lift attachment system in accordance with an example embodiment.

FIG. 12 is a frontal view of a lift attachment system in accordance with an example embodiment.

FIG. 13 is a rear view of a lift attachment system in accordance with an example embodiment.

FIG. 14 is a top view of a lift attachment system in accordance with an example embodiment.

FIG. 15 is a bottom view of a lift attachment system in accordance with an example embodiment.

FIG. 16a is a side view of an actuator for use with one embodiment of the present invention in a first position.

FIG. 16b is a side view of an actuator for use with one embodiment of the present invention in a second position.

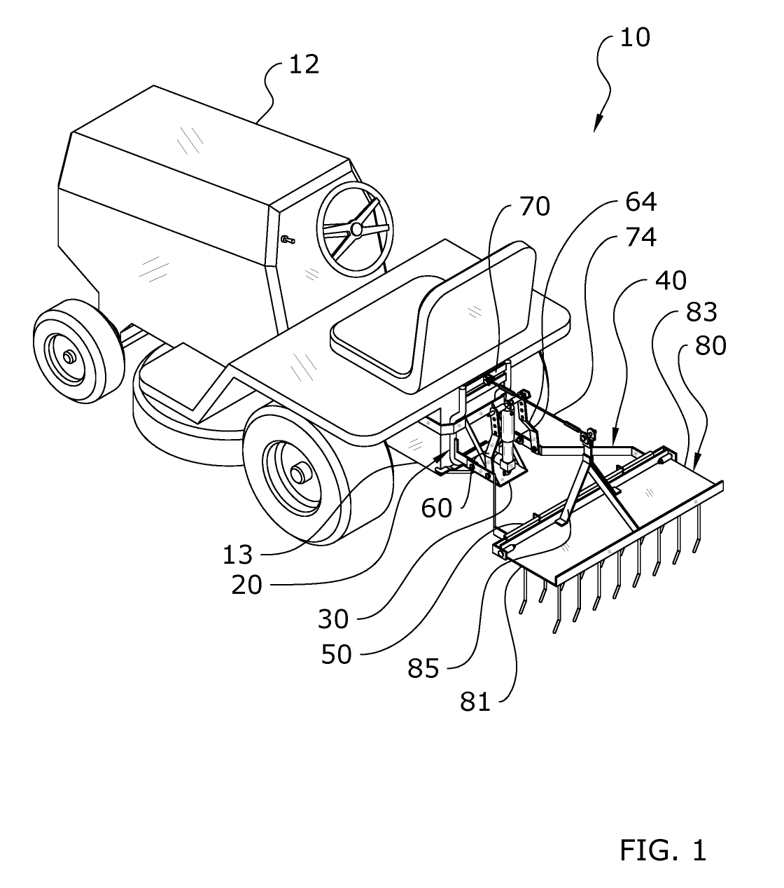

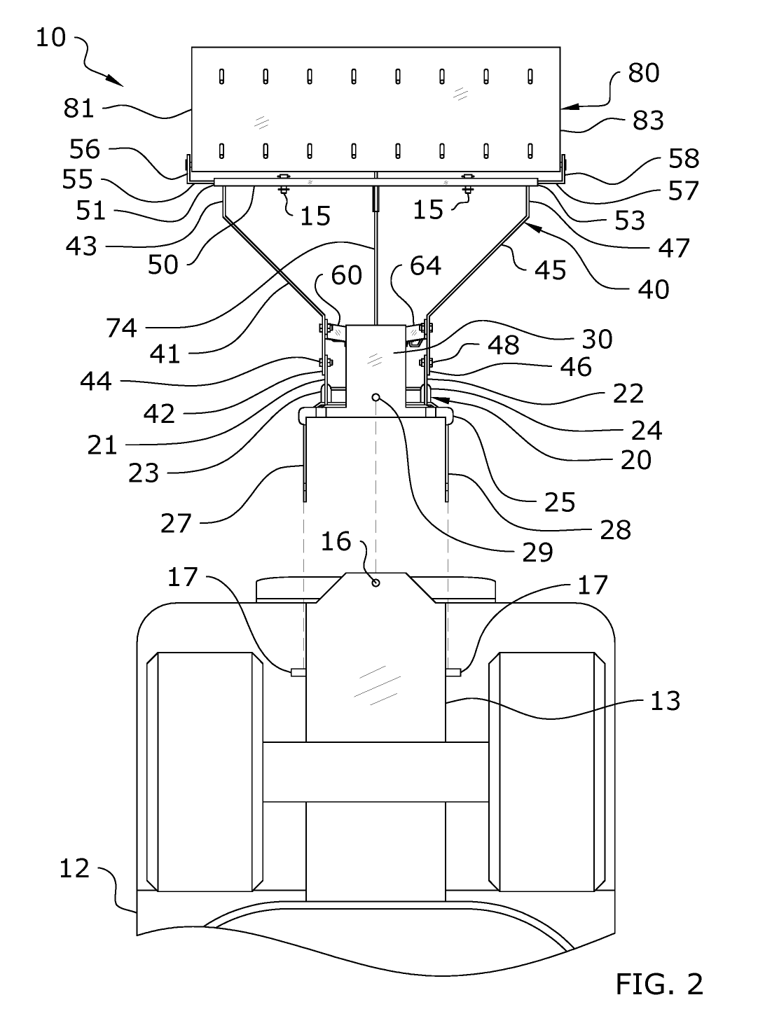

### DETAILED DESCRIPTION

A. Overview.

An example lift attachment system generally comprises a base frame 20 which is removably connected to a vehicle 12, such as at its rear frame 13. A support frame 40 is pivotally connected to the base frame 20. An actuator 32 is connected between the support frame 40 and the base frame 20 such that the support frame 40 may pivotally adjust with respect to the base frame 20. The support frame 40 includes a width-adjustable attachment mount 50 which is adapted to removably receive one of a plurality of different attachments 80. By removably connecting the attachment 80 to the support frame 40, the attachment 80 may be pivotally adjusted (such as lifted or lowered) via activation of the actuator 32. By connecting the base frame 20 to a vehicle 12, one may adjust an attachment 80 while in use on a vehicle 12 to improve efficiency and prevent constant manual adjustments. The figures illustrate the vehicle 12 as comprising a yard tractor. It should be appreciated that the present invention's scope should not be limited in that regard. The illustrations of a yard tractor are merely for exemplary purposes only. It should be appreciated that the present invention may function with a wide range of vehicles, whether motorized or non-motorized. The present invention may be utilized on cars, trucks, tractors, skid loaders, or any other vehicle.

B. Base Frame.

As shown throughout the figures, the present invention comprises a base frame 20 which is adapted to be removably attached to a vehicle 12, such as a lawn tractor as shown in the figures. The structure, configuration, orientation, and size of the base frame 20 may vary in different embodiments of the present invention. Further, it should be appreciated that there are many methods by which the base frame 20 may be removably connected to the vehicle. Thus, the present invention should not be construed as limited by the exemplary descriptions and illustrations herein with regard to the configuration of the base frame 20 or its manner of attachment to the vehicle 12.

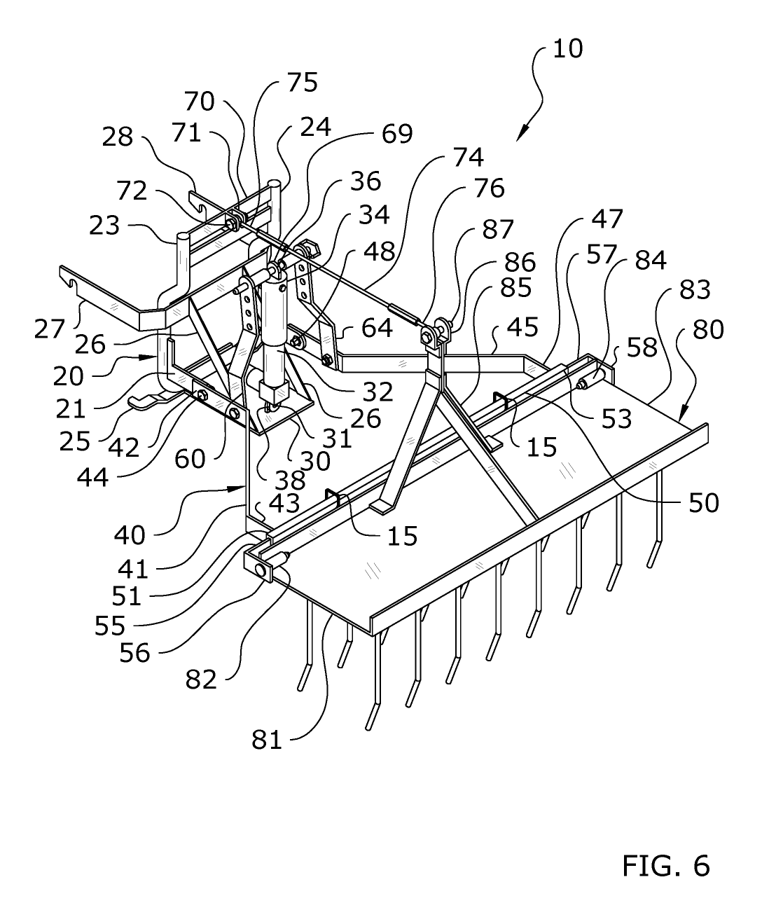

In the exemplary embodiment shown in the figures, the base frame 20 comprises a pair of horizontal members 21, 22 which extend substantially in parallel with respect to each other. A first vertical member 23 extends upwardly from the first horizontal member 21 and a second vertical member 24 extends upwardly from the second horizontal member 22 as shown in FIG. 6. The vertical members 23, 24 will generally extend along the rear frame 13 of the vehicle 12 when the base frame 20 is attached thereto. The horizontal members 21, 22 generally extend outwardly in a direction away from the vehicle 12 where they either support or connect to the actuator base 30

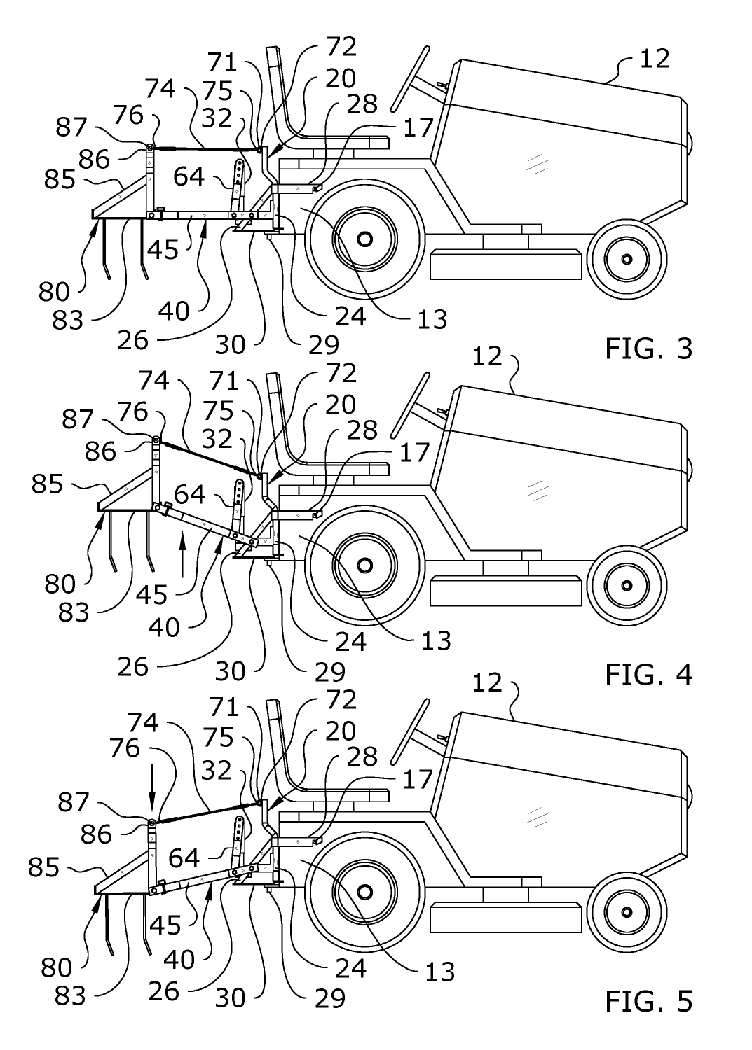

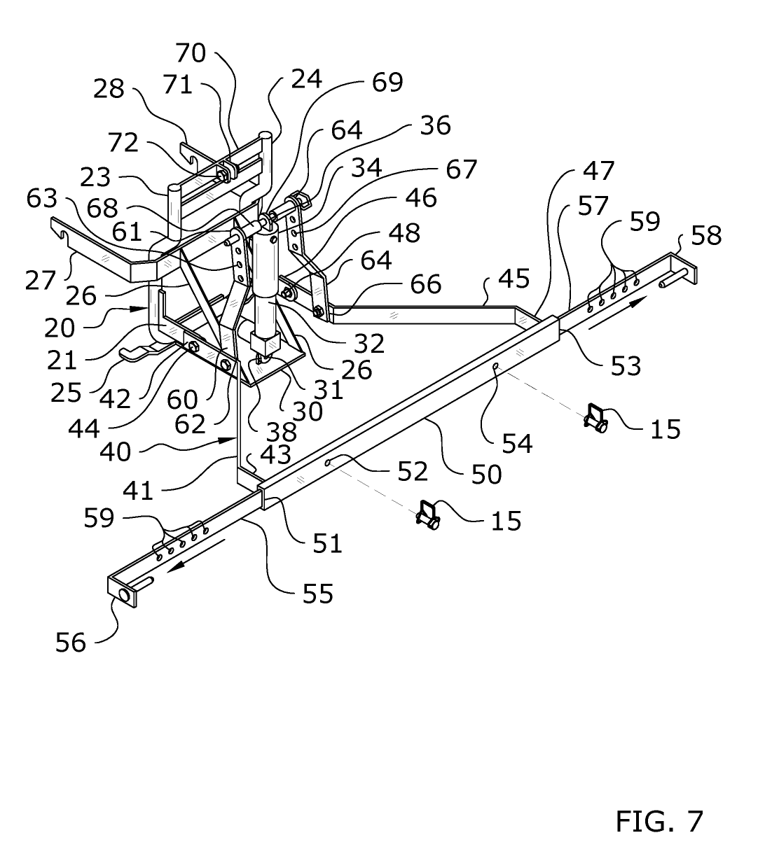

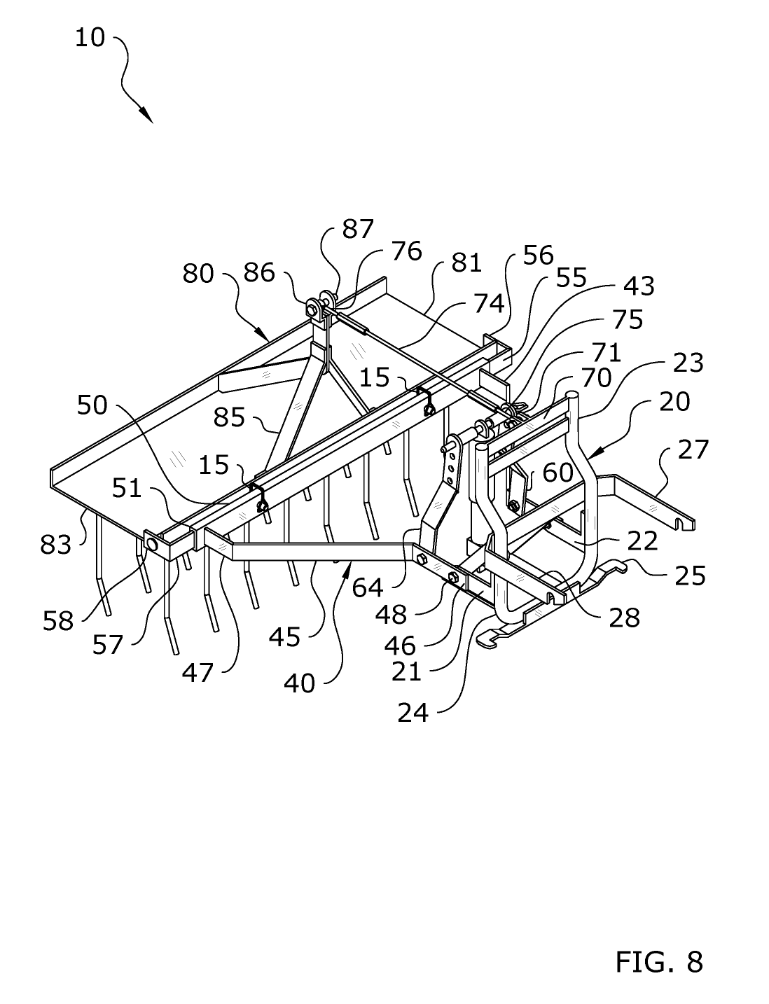

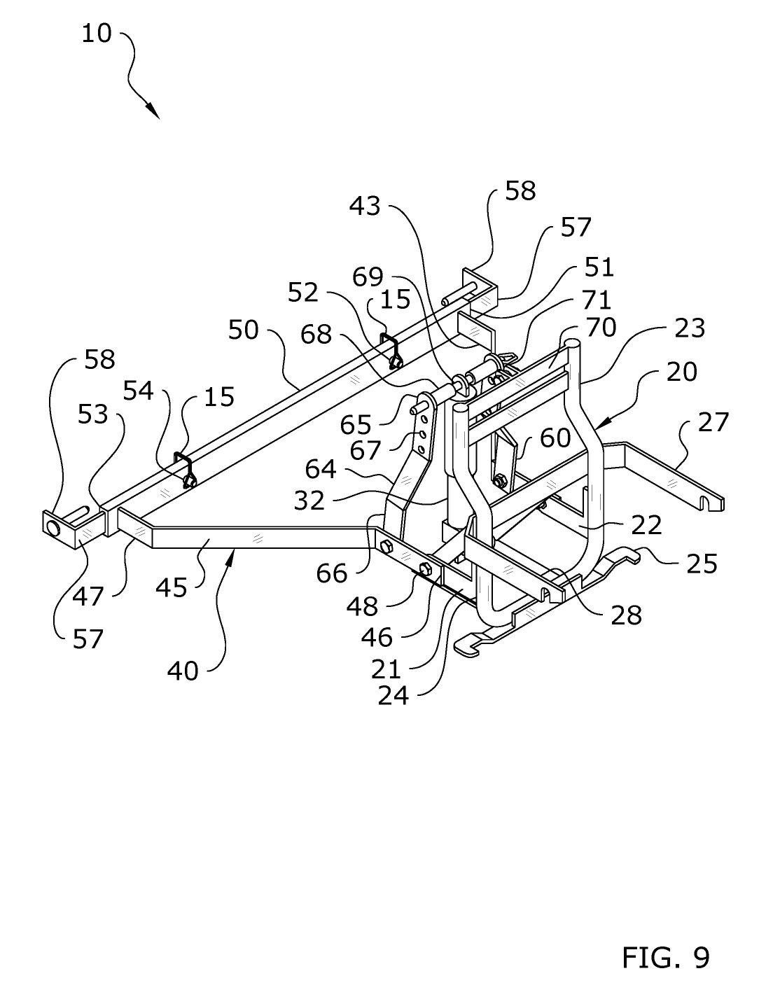

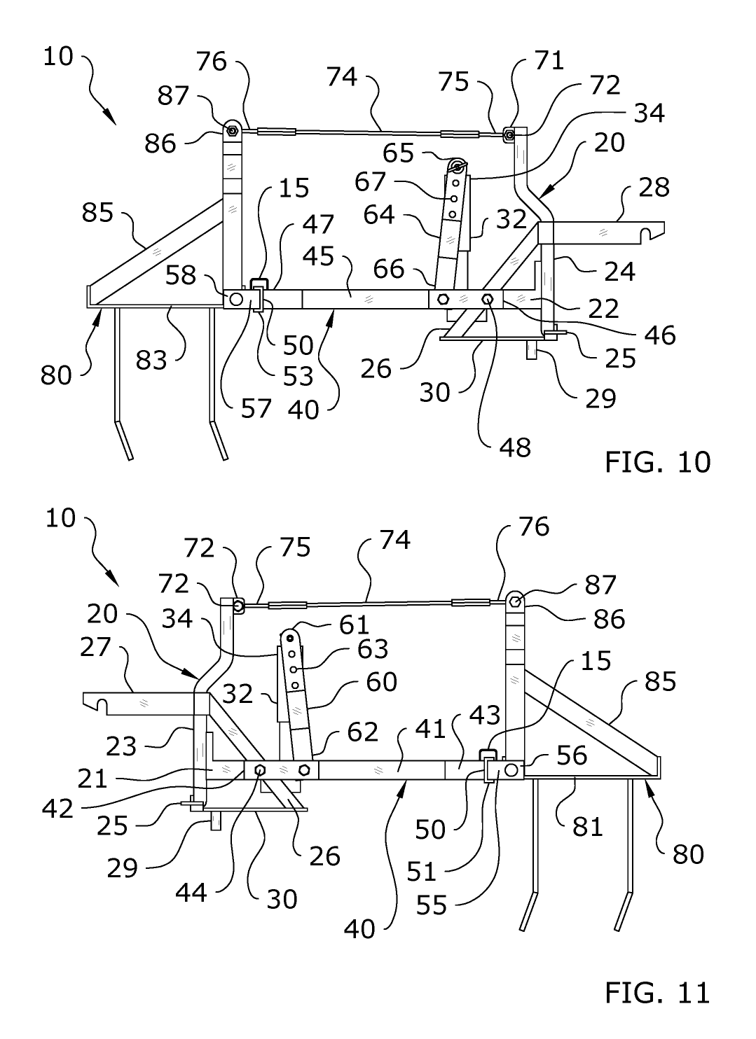

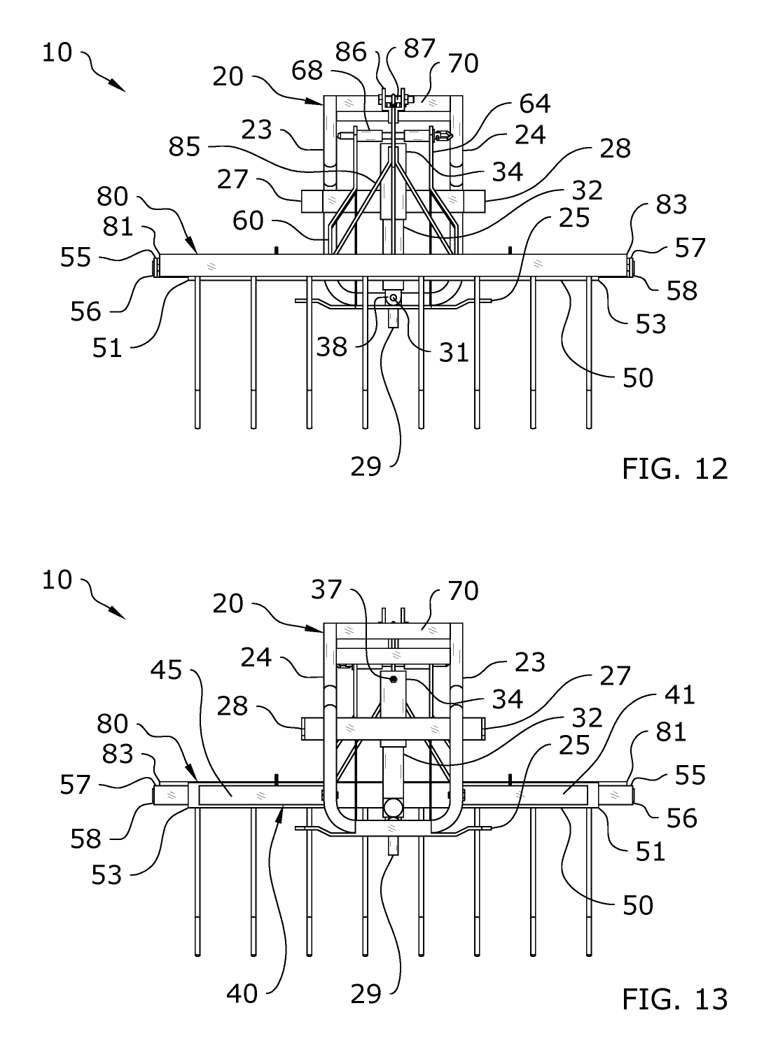

As best shown in FIG. 7, a lower support 25 may extend across the base frame 20. The lower support 25 may comprise an elongated member which extends outwardly from both of the horizontal members 21, 22 of the base frame 20. The lower support 25 is generally utilized to provide additional support for the present invention when attached to a vehicle 12. As shown in FIGS. 3-5, the lower support 25 will generally rest against the rear frame 13 of the vehicle 12 (either above or below) to provide such additional support.

As best shown in FIGS. 3-5, a pair of mount arms 27, 28 generally extend toward the vehicle 12 from the base frame 20. The mount arms 27, 28 are utilized to removably attach the base frame 20 to the vehicle 12. Generally, the mount arms 27, 28 will engage with the rear frame 13 of the vehicle 12. In some embodiments, the mount arms 27, 28 may be adapted to easily snap into and out of interconnection with shoulder bolts 17 included on the rear frame 13 of many vehicles 12.

The mount arms 27, 28 may be connected to the base frame 20 itself or, as shown in FIG. 6, may be supported by cross arms 26 which extend from the actuator base 30. In some embodiments, the mount arms 27, 28 may be integrally formed with the base frame 20. Generally, a first mount arm 27 will extend toward the vehicle 12 from a first side of the base frame 20 and a second mount arm 28 will extend toward the vehicle 12 from a second side of the base frame 20.

The first and second mount arms 27, 28 generally extend in parallel. As shown in the figures, the first and second mount arms 27, 28 may include notches which aid in connecting to the rear frame 13 of the vehicle 12. Any method known in the art may be utilized for removably mounting the first and second mount arms 27, 28 to the vehicle 12, and the scope of the present invention should not be construed as limited by the exemplary figures or descriptions herein.

As shown in the figures, the base frame 20 may include a mounting pin 29 which aids in securing the base frame 20 to the vehicle 12. The mounting pin 29 may comprise an elongated member which is adapted to fit within a hitch receiver 16 on the rear frame 13 of the vehicle 12. The mounting pin 29 will generally extend downwardly from the lower surface of the base frame 20 so that it may engage with the hitch receiver 16 or any other opening on the vehicle 12. The mounting pin 29 may be locked in place with a locking pin or other structure to hold the mounting pin 29 in place. Taken together, the mounting pin 29 and mount arms 27, 28 allow for quick connect and disconnect for the base frame 20.

C. Actuator.

The present invention generally utilizes an actuator 32 which is connected between the base frame 20 and the support frame 40. Movement of the actuator 32 pivots the support frame 40 with respect to the base frame 20, thus allowing for adjustment of any attachment 80 which is connected to the support frame 40. Various types of actuators 32 may be utilized, though a preferred embodiment utilizes an electric linear actuator. By using an electric actuator 32, the controller 18 for the actuator 32 may be positioned anywhere that can be electronically connected to the actuator 32. For example, a controller 18 may be positioned in the vehicle 12 itself and electrically interconnected with the actuator 32, either wirelessly or by a cord 39, thus allowing operation of the actuator 32 from the vehicle 12.

The lower end of the actuator 32 is generally pivotally connected to an actuator base 30, such as by a pivot pin 31 and actuator bracket 38 as shown in the figures. The actuator base 30 will generally either extend from or be connected to the support frame 40 as shown in FIG. 6. The actuator base 30 generally comprises a flat structure such as a plate which provides support for the actuator 32 as it is pivotally connected to the support frame 40. The actuator base 30 is generally interconnected to the actuator 32 via an actuator bracket 38 which allows pivotal connection between the actuator 32 and the actuator base 30.

As shown in the figures, the shaft 33 of the actuator 32 may be surrounded by an actuator cover 34. The actuator cover 34 comprises a hollow, elongated housing which may be positioned over the shaft 33 of the actuator 32. A fastener 37 extends through both the actuator cover 34 and a shaft bracket 36 on the shaft 33 of the actuator 32 to secure the actuator cover 34 around the actuator 32. When the fastener 37 is so inserted, the actuator cover 34 raises and lowers with the shaft 33. When the fastener 37 is removed, the actuator cover 34 may freely “float”. This floating configuration allows the present invention to traverse uneven ground when the actuator 32 is lowered.

The actuator cover 34 may include its own cover bracket 36 which is connected to a raised cross support 68, which itself is linked via vertical supports 60, 64 with the support frame 40. Thus, the lower end of the actuator 32 is connected to the base frame 20 and the actuator cover 34 is connected to the support frame 40. Accordingly, extension or retraction of the actuator 32 will pivot the support frame 40 with respect to the base frame 20 (and thus the vehicle 12).

D. Support Frame.

As shown throughout the figures, a support frame 40 may be included which is pivotally connected to the base frame 20. The support frame 40 may comprise various configurations and thus should not be construed as limited in that regard by the exemplary descriptions and figures herein. The shape, size, configuration, and orientation of the support frame 40 may vary for different applications of the present invention.

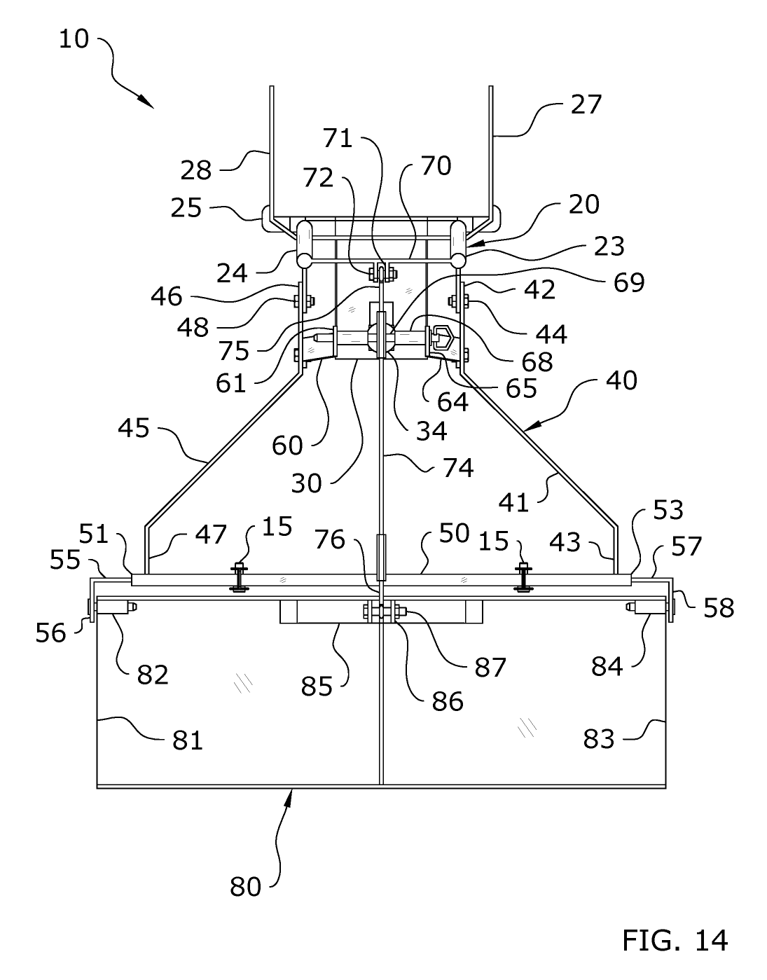

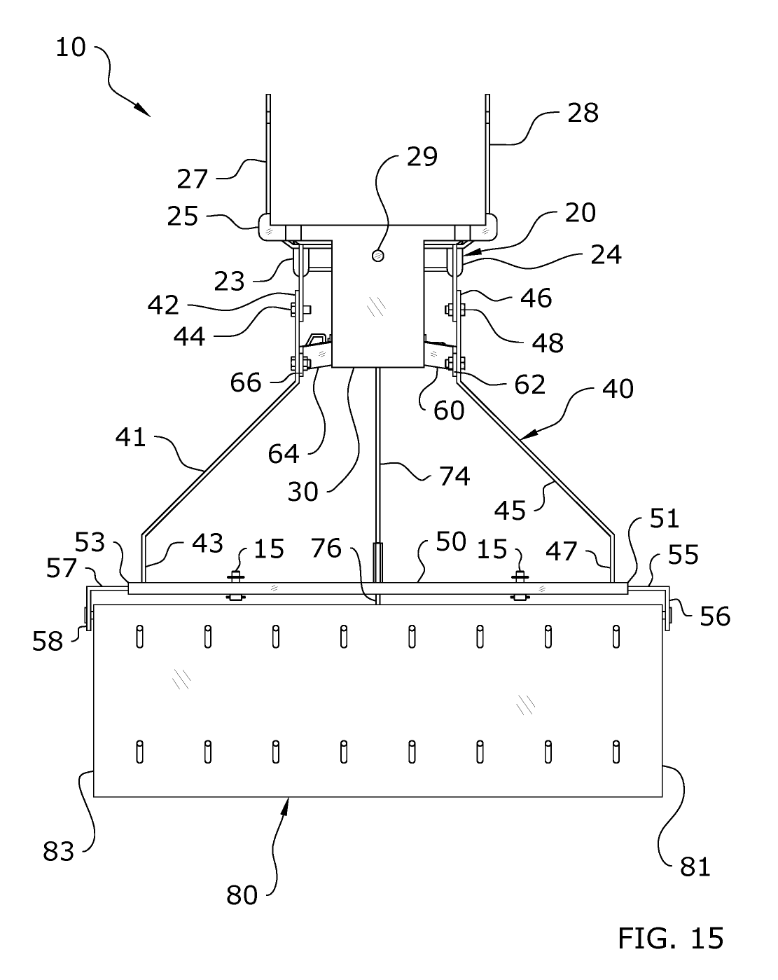

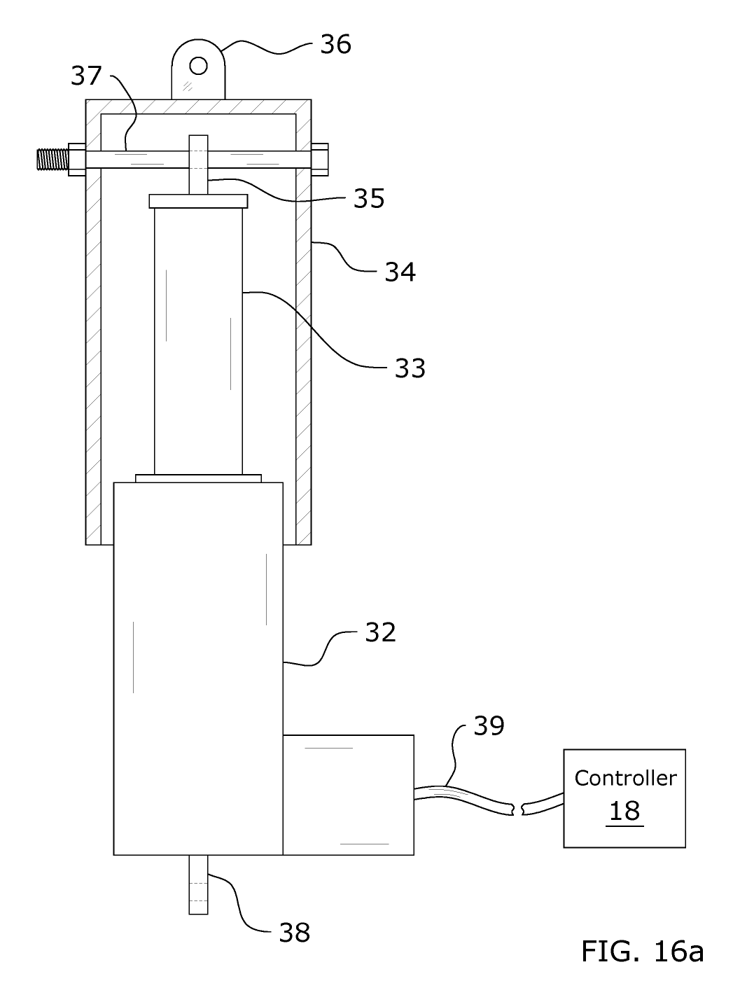

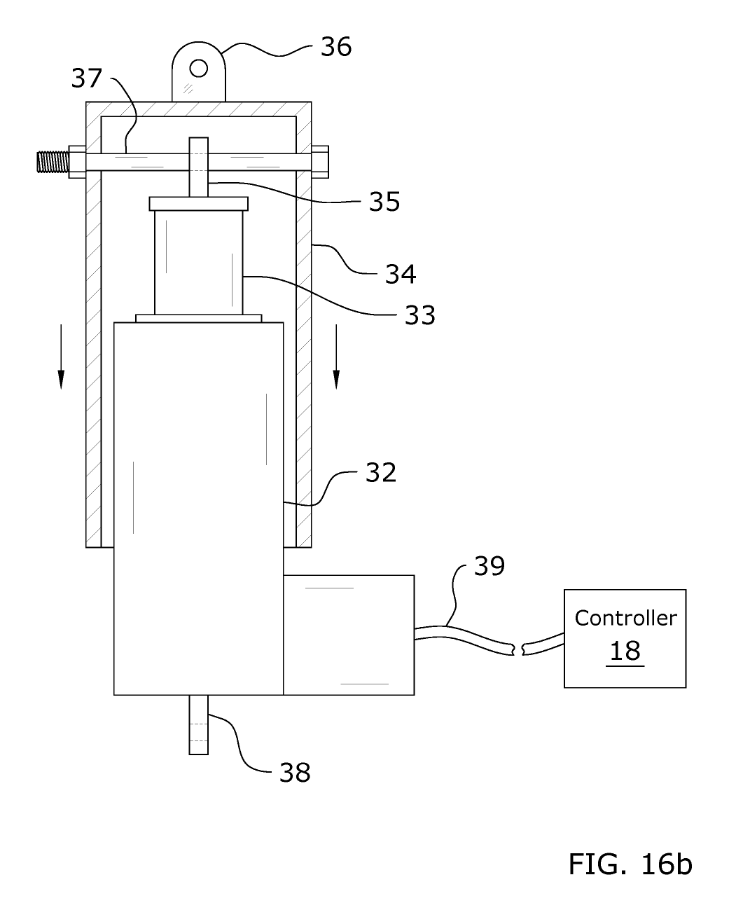

In one embodiment as shown in the figures, the support frame 40 comprises a first arm 41 and a second arm 45, with both arms 41, 45 being pivotally connected to the base frame 20. As best shown in FIG. 14, a first arm 41 is generally pivotally connected to the first horizontal member 21 of the base frame 20 at its first end 42 via a first arm pivot pin 44. Similarly, a second arm 45 is generally pivotally connected to the second horizontal member 22 of the base frame 20 at its first end 46 via a second arm pivot pin 48.

The respective second ends 43, 47 of the arms 41, 45 are either integrally formed with or connected to an attachment mount 50 as best shown in FIG. 14. The attachment mount 50 is utilized to removably connect one of a plurality of different attachments 80 to the support frame 40. When so connected, the attachment 80 will be adjustable in various directions via pivoting movement of the support frame 40 with respect to the base frame 20.

The attachment mount 50 will generally comprise an elongated member having a first end 51 and a second end 53 as shown in the figures. The figures illustrate the attachment mount 50 as comprising a flat structure. It should be appreciated that, in some embodiments, the attachment mount 50 may comprise a round structure, such as through the use of an elongated tube.

The attachment mount 50 is preferably width-adjustable so that a wide range of attachments 80 may be utilized with the present invention. Any type of width-adjustment methodology known in the art may be utilized. In the embodiment shown in the figures, the attachment mount 50 includes a first side adjuster 55 slidably positioned within its first end 51 and a second side adjuster 57 slidably positioned within its second end 53.

Adjuster openings 59 are provided along the length of the adjusters 55, 57 which may be interconnected with corresponding locking openings 52, 54 on the attachment mount 50. A locking pin 15, such as the U-shaped pins shown in the figures, may be inserted through both the first locking opening 52 and the second locking opening 54 to interconnect with the adjuster openings 59 and thus lock the first and second side adjusters 55, 57 in place.

The first side adjuster 55 generally includes a first mounting portion 56 and the second side adjuster 57 may include a second mounting portion 58. The mounting portions 56, 58 extend perpendicularly with respect to the side adjusters 55, 57 and are generally connected directly to the attachment 80, such as via bolts which are fit within corresponding receivers 82, 85 on the attachment 80 itself.

E. Actuator Linkage.

The present invention may utilize an actuator linkage to interconnect the actuator cover 34 of the actuator 32 with the support frame 40. The actuator linkage may comprise an inverted U-shape and thus comprise a first vertical support 60, a second vertical support 64, and a cross support 68 as shown in the figures.

The first vertical support 60 generally comprises an elongated member having a plurality of first vertical apertures 63 along its length between its upper and lower ends 61, 62. The lower end 62 of the first vertical support 60 is connected to the first arm 41 of the support frame 40 as shown in FIG. 6. Similarly, the second vertical support 64 may comprise an elongated member with a plurality of second vertical apertures 67 along its length between its upper and lower ends 65, 66.

The cross support 68 is selectively and adjustable positioned between the first and second vertical supports 60, 64 to form the inverted U-shaped structure of the actuator linkage. Using the vertical apertures 63, 67, the effective height of the actuator 32 may be adjusted via adjustment of the cross support 68 to which the actuator 32 is connected. The cross support 68 will preferably be rotatably positioned between the vertical supports 60, 64 with use of the vertical apertures 63, 67.

As described, the actuator cover 34 of the actuator 32 is preferably pivotally connected to the cross support 68. Motion applied to the cross support 68 by the actuator 32 is transferred to the support frame 40 via the vertical supports 60, 64. The cross support 68 may include a pivot portion 69, or a bearing or the like, to effectuate the pivotal connection between the second end 34 of the actuator 32 and the cross support 68.

The present invention may also utilize a link 74 between the base frame 20 and the attachment 80 to provide further stability. In the embodiment shown in the figures, a link support 70 extends across the base frame 20, such as between the first and second vertical members 23, 24 as shown in the figures. A link bracket 71 with a link pivot pin 72 extends towards the vehicle 12 from the link support 70, which may comprise an elongated member.

A link 74, which may comprise an elongated rod, chain, cord, or the like, is connected at its first end to the link support 70 and at its second end to the mounting bracket 86 of the attachment 80. Thus, the link 74 will extend between the base frame 20 and the attachment 80 as shown in the figures. Both ends 75, 76 of the link 74 are preferably pivotally interconnected, such that the first end 75 of the link 74 is pivotally connected to the link bracket 71 of the link support 70 and the second end 76 of the link 74 is pivotally connected to the mounting bracket 86 of the attachment 80.

F. Attachment.

Various attachments may be utilized with the present invention. While the figures illustrate only one type of attachment 80 for exemplary purposes, the present invention should not in any way be construed as being limited in that regard. The present invention is well-suited for fitting a variety of different types of attachments 80; particularly with use of the width-adjustable attachment mount 50 and height-adjustable actuator 32.

Any type of attachment 80 which is desirable to be towed by a vehicle 12 may be utilized. For example and without limitation in any regard, attachments 80 that may be utilized include dethatchers, spikers, aerators, and the like. Various other landscaping attachments 80 are well-suited for the present invention. Attachments 80 are in no way limited by industry, however, and the principles of the present invention could be applied across a wide range of industries and home use.

Generally, the attachment 80 will comprise a first side 81 having a first receiver 82 and a second side 83 having a second receiver 84. The first receiver 82 is removably connected to the first arm 41 of the support frame 40 and the second receiver 84 is removably connected to the second arm 45 of the support frame 40. Bolts extending from the support frame 40 may be positioned and locked within the receivers 82, 84 to effectuate a quick-connect configuration. Other means of attachments may also be utilized.

The attachment 80 may include a mounting support 85 extending upwardly therefrom. The mounting support 85 may include a mounting bracket 86 near its upper end. In those cases, a pivot pin 87 may be utilized to connect the link 74 with the mounting bracket 86 in a pivotal manner as shown in the figures. This provides additional stability for the attachment 80 as it is adjusted by the present invention.

G. Operation of Preferred Embodiment.

In use, the base frame 20 is first removably attached to the vehicle 12. The present invention provides a quick-connect and quick-disconnect configuration to ease attachment and removal from a vehicle 12. In most embodiments, the base frame 20 is attached to the rear frame 13 of the vehicle 12, though other locations may be utilized.

To connect the base frame 20 to the vehicle 12, the mounting pin 29 extending from the bottom end of the base frame 20 is inserted into the hitch receiver 16 of the vehicle 12. A locking key or pin may be inserted therein to retain in place. With the mounting pin 29 so installed, the base frame 20 may be pivoted onto the rear frame 13 of the vehicle 12. The mount arms 27, 28 will provide anchoring in combination with the engaged mounting pin 29.

With the base frame 20 connected to the vehicle 12, various attachments 80 may be quickly and removably connected to the attachment mount 50 of the support frame 40, which is pivotally connected to the base frame 20. The attachment 80 may be quickly and efficiently connected to the attachment mount 50 by engaging bolts on the mounting portions 56, 58 with the receivers 82, 84 on the attachment 80. A link 74 may be connected between the link support 70 of the base frame 20 and the mounting bracket 86 of the attachment 80. When so connected, the attachment 80 will be adjusted along with the support frame 20.

With the attachment 80 connected to the support frame 40, and the base frame 20 connected to the vehicle 12, the present invention is ready for use. By extending or retracting the actuator 32, the support frame 40 will be pivoted upwardly or downwardly to lift or lower the attachment 80. Thus, the present invention will provide adjustment of the attachment 80. If a controller is linked to the vehicle 12, the attachment 80 may be adjusted from the vehicle 12 itself

Unless otherwise defined, all technical and scientific terms used herein have the same meaning as commonly understood by one of ordinary skill in the art to which this invention belongs. Although methods and materials similar to or equivalent to those described herein can be used in the practice or testing of the lift attachment system, suitable methods and materials are described above. All publications, patent applications, patents, and other references mentioned herein are incorporated by reference in their entirety to the extent allowed by applicable law and regulations. The lift attachment system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A lift attachment, comprising:
a base frame for removable attachment to a vehicle;
a support frame pivotally connected to the base frame, wherein the support frame includes an attachment mount for removably connecting an attachment to the support frame; and
an actuator connected between the base frame and the support frame for pivoting the support frame with respect to the base frame.

2. The lift attachment of claim 1, wherein the attachment mount is width-adjustable.

3. The lift attachment of claim 1, wherein the base frame comprises a first mount arm and a second mount arm, wherein the first mount arm and the second mount arm are each adapted to removably connect to the vehicle.

4. The lift attachment of claim 3, wherein the base frame includes a mounting pin to removably connect to the vehicle.

5. The lift attachment of claim 1, wherein the support frame is adapted to be lifted and/or lowered by the actuator.

6. The lift attachment of claim 1, wherein the support frame comprises a first arm pivotally connected to the base frame and a second arm pivotally connected to the base frame.

7. The lift attachment of claim 6, wherein the attachment mount extends between the first arm and the second arm.

8. The lift attachment of claim 7, further comprising a first vertical support extending upwardly from the first arm and a second vertical support extending upwardly from the second arm.

9. The lift attachment of claim 8, further comprising a cross arm removably connected between the first vertical support and the second vertical support.

10. The lift attachment of claim 9, wherein the first vertical support includes a plurality of first vertical apertures and wherein the second vertical support includes a plurality of second vertical apertures, wherein the cross arm is selectively connected between one of the first vertical apertures and one of the second vertical apertures.

11. The lift attachment of claim 10, wherein a first end of the actuator is connected to the base frame and wherein a second end of the actuator is connected to the cross arm.

12. The lift attachment of claim 1, further comprising a link connected between the support frame and the attachment.

13. The lift attachment of claim 12, wherein the link is comprised of a cord.

14. The lift attachment of claim 12, wherein the support frame includes a link support, wherein a first end of the link is pivotally connected to the link support.

15. The lift attachment of claim 14, wherein a second end of the link is pivotally connected to attachment.

16. A lift attachment system, comprising:
a vehicle, wherein the vehicle includes a hitch received, a first shoulder bolt, and a second shoulder bolt;
a base frame removably attached to the vehicle, wherein the base frame includes a mounting pin adapted to be removably engaged with the hitch receiver, wherein the base frame includes a first mount arm adapted to be removably engaged with the first shoulder bolt and a second mount arm adapted to be removably engaged with the second shoulder bolt;
a support frame pivotally connected to the base frame;
an attachment removably connected to the support frame, wherein the support frame includes an attachment mount for removably connecting the attachment to the support frame; and
an actuator connected between the base frame and the support frame for pivoting the support frame with respect to the base frame.

17. The lift attachment system of claim 16, wherein the vehicle comprises a yard tractor.

18. The lift attachment system of claim 17, wherein the attachment comprises a dethatcher attachment.

19. The lift attachment system of claim 16, wherein the actuator comprises a linear actuator.

20. The lift attachment system of claim 16, wherein the support frame includes a width-adjustable attachment mount for removably connecting to the attachment.
